(19) United States
(12) Patent Application Publication
(10) Pub. No.: US 2012/0038724 A1
(43) Pub. Date: Feb. 16, 2012

(54) ADD-ON TYPE ULTRAVIOLET IRRADIATION APPARATUS AND IMAGE FORMING APPARATUS

(76) Inventor: Kazuo Sanada, Ashigarakami-gun (JP)

(21) Appl. No.: 13/206,127

(22) Filed: Aug. 9, 2011

(30) Foreign Application Priority Data
Aug. 10, 2010 (JP) 2010-179665

(51) Int. Cl. B41J 2/01

(52) U.S. Cl. 347/102

(57) ABSTRACT

An add-on type ultraviolet irradiation apparatus for being coupled to an inkjet recording apparatus that does not include an ultraviolet irradiation device for curing ultraviolet curable ink, so as to make the inkjet recording apparatus usable as an ultraviolet curing type image forming apparatus, includes: a detection device which detects a conveyance operation of a recording medium performed by the inkjet recording apparatus; an ultraviolet light source for radiating ultraviolet light onto an ultraviolet curable ink deposited on the recording medium by the inkjet recording apparatus; and an exposure control device which controls exposure performed by the ultraviolet light source according to a detection signal obtained from the detection device.

### BACKGROUND OF THE INVENTION

1. Field of the Invention

The present invention relates to an add-on type accessory apparatus which is used in combination with an inkjet recording apparatus, and more particularly to an ultraviolet irradiation apparatus for curing ultraviolet-curable ink, and to an image forming apparatus using same.

2. Description of the Related Art

An inkjet recording apparatus is known which uses ink that is cured by irradiation of ultraviolet light (ultraviolet-curable ink) (Japanese Patent Application Publication No. 2005-319720 and Japanese Patent Application Publication No. 2008-168502). In general, in the case of a system which comprises a non-scanning type of ultraviolet irradiation apparatus in which an ultraviolet (UV) exposure unit is disposed at a prescribed distance in the paper conveyance direction from an inkjet head unit, control to convey paper is implemented until an image area on which an image is formed by the inkjet unit has passed the UV exposure unit, or on/off switching of UV exposure is controlled on the basis of the on/off switching of paper conveyance, in order for the whole of the image area to be reliably exposed with UV light.

FIG. 9 of Japanese Patent Application Publication No. 2005-319720 discloses a system which combines a full line type inkjet recording head and a non-scanning type ultraviolet irradiation apparatus, and discloses a composition in which conveyance is controlled in a sub-scanning direction until a recording end scanning line has passed through the range of ultraviolet irradiation (paragraphs 0040 to 0042 in Japanese Patent Application Publication No. 2005-319720).

On the other hand, Japanese Patent Application Publication No. 2008-168502 discloses a control method for starting UV irradiation when conveyance of paper is started and halting UV irradiation when the conveyance is halted. Furthermore, Japanese Patent Application Publication No. 2008-168502 proposes a device which prevents non-uniformity of the amount of irradiation, by adjusting the UV irradiation intensity in accordance with the conveyance speed or adjusting the conveyance speed in accordance with the irradiation intensity, or the like.

In such systems as described above, the apparatus design is based on the assumption that ultraviolet-curable ink is to be used, and the carriage control of the inkjet head unit, the paper conveyance control, the UV exposure control, and the like, are managed in the sequence of the overall apparatus. In other words, the apparatus is composed as a dedicated inkjet system which is specifically designed for use with UV-curable ink.

However, in the case of existing inkjet printers which do not comprise a UV curing system, for example, if it were possible to load ultraviolet-curable ink instead of normal ink and use the printer as a UV curing system, then users of existing printers would be able to obtain the merits of a UV curing system, which would be very desirable indeed.

From this viewpoint, the present inventor has undertook development of an add-on type UV curing auxiliary unit (an add-on type ultraviolet irradiation apparatus) which can be combined additionally with an existing inkjet printing system that is not provided with an UV curing system. In a system which uses an add-on type UV curing unit of this kind, it is desirable to minimize the interface signals which are exchanged between the UV curing unit and the inkjet recording apparatus.

On the other hand, in an add-on type system of this kind, similarly to a conventional dedicated system, it is desirable to achieve control for conveying paper continuously until the time at which the image area recorded by the inkjet head section passes the UV exposure unit, and to prevent the occurrence of fractures and discoloration caused by over-curing as a result of performing excessive exposure onto stationary paper at the end of recording or in the event of a jam or other abnormality, as well as implementing control to prevent the occurrence of abnormal heat generation, ignition, or the like, due to excessive exposure.

### SUMMARY OF THE INVENTION

The present invention has been contrived in view of the aforementioned circumstances, an object thereof being to provide an add-on type ultraviolet light irradiation apparatus which achieves a UV curing system simply by combination with an existing inkjet recording apparatus not comprising a UV curing system, and which enables suitable control of UV exposure in coordination with the conveyance of paper. A further object of the invention is to provide an image forming apparatus which uses this kind of add-on type ultraviolet light irradiation apparatus.

The following modes of the invention are proposed in order to achieve an aforementioned object.

In order to attain an object described above, one aspect of the present invention is directed to an add-on type ultraviolet irradiation apparatus for being coupled to an inkjet recording apparatus that does not include an ultraviolet irradiation device for curing ultraviolet curable ink, so as to make the inkjet recording apparatus usable as an ultraviolet curing type image forming apparatus, the add-on type ultraviolet irradiation apparatus comprising: a detection device which detects a conveyance operation of a recording medium performed by the inkjet recording apparatus; an ultraviolet light source for radiating ultraviolet light onto an ultraviolet curable ink deposited on the recording medium by the inkjet recording apparatus; and an exposure control device which controls exposure performed by the ultraviolet light source according to a detection signal obtained from the detection device.

According to this aspect of the invention, it is possible to achieve a UV curing system simply by coupling the ultraviolet irradiation apparatus according to this aspect of the present invention, to an existing inkjet recording apparatus which does not comprise a UV exposure function.

Desirably, the exposure control device is provided independently from a control device which controls an operation of the inkjet recording apparatus, and control of ultraviolet irradiation performed by the exposure control device and the operation of the inkjet recording apparatus performed by the control device are coordinated with each other via the detection signal from the detection device without transferring a control signal between the exposure control device and the control device, in such a manner that the inkjet recording apparatus functions as the ultraviolet curing type image forming apparatus.

The control device which controls the operation of the inkjet recording apparatus and the exposure control device which controls the operation of the add-on type ultraviolet irradiation apparatus are mutually independent, and while each of these control devices implements independent control, the operation of the inkjet recording apparatus and the operation of the ultraviolet irradiation apparatus are coordinated overall and a function of a UV curable image forming apparatus is obtained. Therefore, it is possible to apply an inkjet recording apparatus to a UV curing system, without requiring extensive modifications or improvements to the inkjet recording apparatus.

Desirably, when a halt of conveyance of the recording medium is detected by the detection device, the exposure control device implements control to halt the exposure performed by the ultraviolet light source.

According to this aspect of the invention, excessive UV exposure onto a stationary recording medium is avoided, and the occurrence of fractures or discoloration as a result of excessive exposure can be prevented, in addition to which the occurrence of abnormal heat generation, and the like, can also be prevented.

Desirably, when an operation of conveyance of the recording medium is detected by the detection device, the exposure control device implements control to start the exposure performed by the ultraviolet light source or to continue the exposure performed by the ultraviolet light source.

According to this aspect of the invention, it is possible to conduct automatic start-up of ultraviolet irradiation (start of exposure) and continued irradiation, in coordination with the image formation operation of the inkjet recording apparatus.

Desirably, the add-on type ultraviolet irradiation apparatus further comprises a platen which is disposed facing the ultraviolet light source and supports, from a rear surface side of the recording medium, the recording medium irradiated with the ultraviolet light from the ultraviolet light source.

A desirable composition is one where ultraviolet light is irradiated from an ultraviolet light source toward a recording medium which is supported on a platen.

Desirably, the add-on type ultraviolet irradiation apparatus further comprises a temperature sensor which detects a temperature of the platen, wherein the temperature sensor is used as the detection device.

The temperature of the platen is higher when ultraviolet light is irradiated while the conveyance of the recording medium is halted, compared to when ultraviolet is irradiated while conveyance of the recording medium is being performed. Therefore, it is possible to detect the state of conveyance of the recording medium indirectly, by detecting the temperature of the platen. In other words, it is possible to utilize a temperature sensor as a device which detects a conveyance operation of the recording medium.

Desirably, the recording medium is a continuous medium, the add-on type ultraviolet irradiation apparatus further comprises an arm position sensor for determining a position of a take-up tension arm which is included in the inkjet recording apparatus and adjusts a tension when the continuous medium is taken up onto a take-up roll of the inkjet recording apparatus, and the arm position sensor is used as the detection device.

According to this aspect of the invention, a detection device (arm position sensor) can be installed easily in the add-on type ultraviolet irradiation apparatus, and can also be achieved by a sensor having an inexpensive composition.

Desirably, the add-on type ultraviolet irradiation apparatus further comprises a timer which is reset in accordance with a signal obtained from the arm position sensor.

For example, a countdown timer is used, and UV exposure is switched off when the timer value reaches zero. Alternatively, a count-up timer is used and UV exposure is switched off when a specified timer value is reached. It is possible to prevent excessive UV exposure of the stationary recording medium by means of a simple device of this kind.

Desirably, the add-on type ultraviolet irradiation apparatus further comprises: a heater which heats the recording medium during ultraviolet irradiation performed by the ultraviolet light source; and a heater control device which controls the heater according to the detection signal obtained from the detection device.

A desirable mode is one where heating is performed by a heater simultaneously with the irradiation of ultraviolet light. In this case, the control of the heater, similarly to UV exposure, is controlled using a detection signal from the detection device, independently of the control system of the inkjet recording apparatus.

Desirably, when a halt of conveyance of the recording medium is detected by the detection device, the heater control device implements control to halt heating performed by the heater.

According to this mode, excessive heating of a stationary recording medium is avoided, and it is possible to prevent the occurrence of abnormal heat generation or deformation of the recording medium, or the like, caused by excessive heat.

Desirably, when an operation of conveyance of the recording medium is detected by the detection device, the heater control device implements control to start heating performed by the heater or to continue the heating performed by the heater.

According to this aspect of the invention, it is possible to conduct automatic start-up of the heater (start of heating) and continued heating, in coordination with the image formation operation of the inkjet recording apparatus.

In order to attain an object described above, another aspect of the present invention is directed to an image forming apparatus comprising: any of the add-on type ultraviolet irradiation apparatuses as defined in the above; and the inkjet recording apparatus that is coupled to the add-on type ultraviolet irradiation apparatus, wherein the inkjet recording apparatus includes: an inkjet head which ejects the ultraviolet curable ink; a conveyance device which conveys the recording medium on which the ultraviolet curable ink ejected from the inkjet head is deposited; and a control device which controls an operation of the inkjet recording apparatus, the operation including control of conveyance of the recording medium performed by the conveyance device and control of ejection of the ultraviolet curable ink from the inkjet head.

According to the present invention, it is possible to achieve a UV curing system simply by combination with an inkjet recording apparatus that is not provided with an ultraviolet irradiation device, and it is possible to achieve coordinated operation of inkjet recording and UV exposure in the overall system.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is an external perspective diagram of an inkjet printer to which an add-on type ultraviolet irradiation apparatus relating to an embodiment of the present invention is applied;

FIG. 2 is a block diagram showing a composition of an inkjet printer relating to an embodiment of the present invention;

FIG. 3 is a block diagram showing an overview of the system composition according to an embodiment of the present invention;

FIG. 4 is a block diagram showing an overview of the system composition of a related-art UV curable printer relating to a comparative example;

FIG. 5 illustrates a timing chart of the operation of the system according to an embodiment of the present invention; and

FIG. 6 is a block diagram showing the composition of an add-on type ultraviolet irradiation apparatus relating to another embodiment of the present invention.

### DETAILED DESCRIPTION OF THE PREFERRED EMBODIMENTS

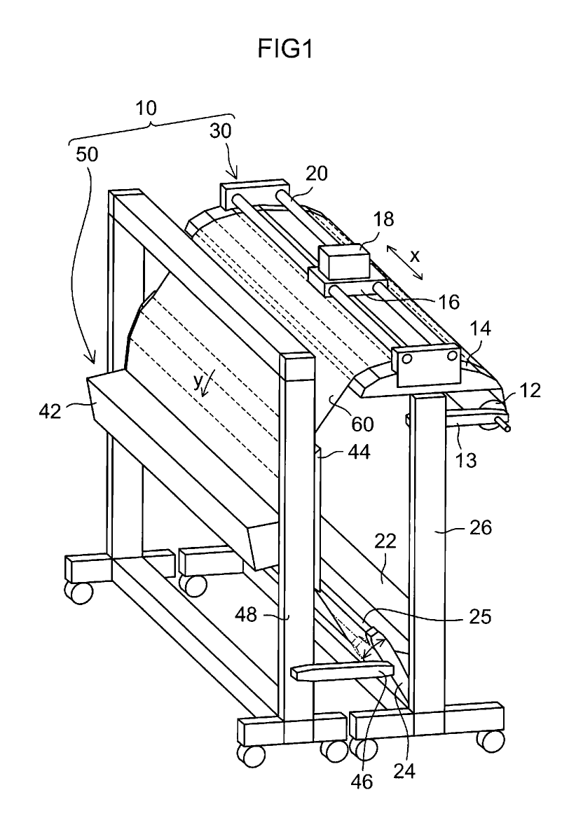

FIG. 1 is an external perspective diagram of an image forming apparatus (inkjet printer) to which an add-on type ultraviolet irradiation apparatus relating to an embodiment of the present invention is applied. The image forming apparatus 10 shown in FIG. 1 is a system formed by combining an inkjet recording apparatus 30 which includes a paper feed roll 12, a platen 14, a carriage 16, an inkjet head 18, a guide rail 20, a take-up roll 22, a take-up tension arm 24, and leg sections 26 supporting these respective elements, with an ultraviolet irradiation apparatus 50 (corresponding to an “add-on type ultraviolet irradiation apparatus”) which includes a non-scanning type ultraviolet light source 42, a platen 44, an arm position sensor 46 and leg sections 48 supporting these respective elements.

Here, terms such as “paper feed” and “paper” are used, but the material of the recording medium 60 is not limited to “paper”. For example, it is possible to use various materials, such as polyvinyl chloride (PVC), which is employed widely in wide-format printers, or other resin sheets, cloth, fabric, or the like.

The paper feed roll 12 is supported by brackets 13 which are fixed to the leg sections 26. A recording medium 60 (hereinafter, called “paper” for the sake of convenience) paid out from the paper feed roll 12 is wound up onto the take-up roll 22, via the first platen 14 and the second platen 44. The direction of conveyance of the recording medium 60 which is moved from the paper feed roll 12 to the take-up roll 22 is called the “sub-scanning direction”, the “paper conveyance direction” or the “y direction”.

The platen 14 is fixed to the upper end portion of the leg sections 26. A pre-heater which pre-heats the recording medium 60, a print heater which improves ink fixing and coloration, and the like, are provided with the platen 14.

Guide rails 20 are arranged extending in the width direction of the recording medium 60 (the direction perpendicular to the sub-scanning direction: the “main scanning direction” or the “x direction”) above the platen 14. The carriage 16 is supported movably in the main scanning direction along the guide rails 20. The inkjet head 18 is mounted on the carriage 16, which moves reciprocally in the width direction of the recording medium 60 (in the main scanning direction).

In the present embodiment, a head unit is employed in which four separate head modules corresponding to the four ink colors of cyan (C), magenta (M), yellow (Y) and black (K) are arranged on the carriage 16, but the types of ink and the number of heads are not limited to this. For example, it is also possible to adopt a composition in which light cyan (LC) ink and light magenta (LM) ink are added, or a composition in which other colors, such as white ink, and the like, are added.

The head modules of the respective colors each have a plurality of nozzles (ink ejection ports). There are no particular restrictions on the nozzle arrangement, and the nozzles may be arranged in one nozzle row, in two staggered rows, or in a multiple-row matrix arrangement or other two-dimensional arrangement. For the ejection energy generation element, it is possible to use a piezoelectric element (piezo actuator), electrostatic actuator, heat generation element, or the like.

Although not shown in the drawings, a replaceable cartridge (ink tank) which stores ultraviolet-curable ink (UV ink) is provided in the inkjet recording apparatus 30 according to the present embodiment. The ink cartridges provided for the respective colors are connected to the inkjet head 18 by ink supply channels (not illustrated) which are formed independently. Ink droplets are ejected from the inkjet head 18 onto the recording medium 60 which has been conveyed on the platen 14, thereby forming an image on the recording medium 60 by means of the ink droplets which are attached to the recording medium 60.

The recording medium 60 on which the image has been formed by the inkjet head 18 is conveyed to the second platen 44. The non-scanning type ultraviolet light source 42 has a paper-wide irradiation range in such a manner that the whole image formation range of the recording medium 60 in the width direction can be simultaneously irradiated with ultraviolet light. For the ultraviolet light source 42, it is possible to use a UV lamp, or an LED element array in which a plurality of ultraviolet LED (light-emitting diode) elements are arranged.

When a recording medium 60 on which an image has been formed by the inkjet head 18 passes below the ultraviolet light source 42, the ink which has been deposited onto the recording medium 60 is cured by ultraviolet light irradiated from the ultraviolet light source 42 onto the ink on the recording medium 60.

The recording medium 60 on which an image has been fixed by curing the ink by UV light exposure is wound up onto the take-up roll 22. The take-up tension arm 24 is a device for preventing excessive tension from being applied to the recording medium 60, by applying a suitable flexure to the recording medium 60 before the take-up roll 22. The take-up tension arm 24 is a swinging arm, the base end portion of which is supported swingably on the lower portions of the leg sections 26. A roller 25 of a length corresponding to the paper width is installed on the take-up tension arms 24. A roller 25 is pressed against the rear surface side of the recording medium 60 (the opposite side to the surface which is exposed with UV light) by the swinging action of the take-up tension arm 24, thereby loosening the pulling of the recording medium 60 and adjusting the tension during take-up.

More specifically, the take-up tension arm 24 is swung at a suitable timing during the take-up operation of the paper onto the take-up roll 22 (during conveyance of the recording medium) (for example, the arm 24 is swung at a prescribed time interval, at a rate of once every several ten seconds), and the recording medium 60 which has passed under the ultraviolet light source 42 is pressed by the roller 25 from the rear surface side (the opposite side to the UV exposure surface). By this means, the length of the recording medium 60 (the amount paid out from the roll) between the second platen 44 and the take-up roll 22 becomes longer, and therefore the take-up tension of the recording medium 60 is loosened when the take-up tension arm 24 returns to its original position. In this way, the tension of the recording medium 60 during take-up onto the take-up roll 22 is adjusted.

An arm position sensor 46 is a non-contact type position determination device which determines the position of the take-up tension arm 24 (the angle of the arm which has swung). For the arm position sensor 46, it is possible to use, for example, a light reflecting sensor which includes a light projecting unit that radiates light onto the side surface portion of the take-up tension arm 24, and a light receiving unit that receives reflected light from the side surface portion. The light reflecting sensor is fixed at a prescribed position on a leg section 48, radiates light onto the take-up tension arm 24, and can determine the position of the take-up tension arm 24 from whether or not the reflected light is detected.

Instead of the reflective sensor described above, it is also possible to use a sensor of another mode, such as a light shielding sensor or a limit switch, or the like.

### Description of Block Diagrams

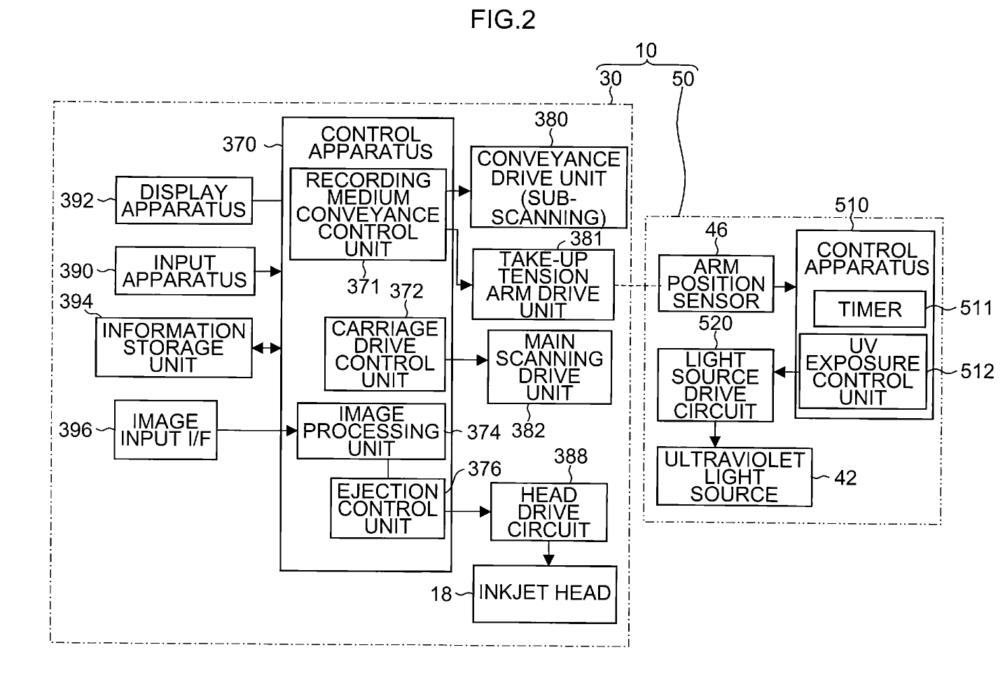

FIG. 2 is a block diagram showing a composition of a control system of the image forming apparatus 10 relating to the present embodiment. As shown in FIG. 2, the inkjet recording apparatus 30 has a control apparatus 370 which forms a control device. For this control apparatus 370, it is possible to use, for example, a computer equipped with a central processing unit (CPU), or the like. The control apparatus 370 functions as a control apparatus for controlling the whole of the inkjet recording apparatus 30 in accordance with a prescribed program, as well as functioning as a calculation apparatus for performing a variety of calculations. The control apparatus 370 includes a recording medium conveyance control unit 371, a carriage drive control unit 372, an image processing unit 374, and an ejection control unit 376. These respective units are achieved by a hardware circuit or software, or a combination of these.

The recording medium conveyance control unit 371 controls a conveyance drive unit 380 (including a drive motor which drives a conveyance roller, or the like, and a drive circuit for the motor), in order to perform conveyance of the recording medium 60, and a take-up tension arm drive unit 381 (including a drive motor and a drive circuit for the motor) for operating the take-up tension arm 24 (see FIG. 1). The recording medium 60 which is conveyed on the platen 14 (see FIG. 1) is conveyed intermittently in swath width units in the sub-scanning direction, in accordance with a repeated scanning operation in the main scanning direction performed by the inkjet head 18 (a printing pass action).

The carriage drive control unit 372 controls a main scanning drive unit 382 (a drive motor and a drive circuit for the motor) for moving the carriage 16 in the main scanning direction. An input apparatus 390, such as an operating panel, and a display apparatus 392, are connected to the control apparatus 370. The input apparatus 390 is a device which enables external operating signals to be input manually to the control apparatus 370, and may employ various formats, such as a keyboard, a mouse, a touch panel, or operating buttons, or the like. The display apparatus 392 may employ various formats, such as a liquid crystal display, an organic EL display, a CRT, or the like. An operator is able to input print conditions, and input and edit additional conditions, and the like, by operating the input apparatus 390, and is able to confirm the input details and various information such as search results, via the display on the display apparatus 392.

Furthermore, an information storage unit 394 which stores various information and an image input interface 396 for acquiring image data for printing are provided in the inkjet recording apparatus 30.

For the image input interface 396, a serial interface, such as USB (Universal Serial Bus), IEEE 1394, an Ethernet (registered tradename), or a wireless network, or the like, or a parallel interface, such as a Centronics interface, or the like, can be used. It is also possible to install a buffer memory (not illustrated) in this portion for achieving high-speed communications.

The image data input via the image input interface 396 is converted into data for printing (dot data) by the image processing unit 374. In general, the dot data is generated by subjecting the multiple-tone image data to color conversion processing and half-tone processing. The color conversion processing is processing for converting image data represented by an sRGB system, (for example, 8-bit image data for each color of RGB) into image data of the respective colors of ink used by the inkjet recording apparatus 30.

A half-toning process is processing for converting the color data of the respective colors generated by the color conversion processing into dot data of respective colors by error diffusion, a threshold value matrix, or the like. The device carrying out the half-toning process may employ commonly known methods of various kinds, such as an error diffusion method, a dithering method, a threshold value matrix method, a density pattern method, and the like. The half-toning process generally converts a tonal image data having M values (M≧3) into tonal image data having N values (N<M). In the simplest example, the image data is converted into dot image data having 2 values (dot on/dot off), but in a half-toning process, it is also possible to perform quantization in multiple values which correspond to different types of dot size (for example, three types of dot: a large dot, a medium dot and a small dot).

The binary or multiple-value image data (dot data) obtained in this way is used for driving (on) or not driving (off) the respective nozzles, or in the case of multiple-value data, is used as ink ejection control data (droplet ejection control data) for controlling the droplet volume (dot size).

The ejection control unit 376 outputs an ejection control signal to the head drive circuit 388 on the basis of dot data generated in the image processing unit 374. Furthermore, the ejection control unit 376 comprises a drive waveform generation unit (not illustrated). The drive waveform generation unit is a device which generates a drive voltage signal waveform for driving the ejection energy generation elements (piezoelectric elements, and the like) which correspond to the respective nozzles of the inkjet head 18. The waveform data of the drive voltage signal is stored previously in the information storage unit 394 and waveform data to be used is output as and when required. The signal (drive waveform) generated by the drive waveform generation unit is supplied to the head drive circuit 388. The signal output from the drive waveform generation unit may be digital waveform data or an analog voltage signal.

The inkjet image recording apparatus 30 shown in the present embodiment employs a drive method in which a common drive power waveform signal is applied to the respective ejection energy generation elements of the inkjet head 18, in units of one head module, and ink is ejected from the corresponding nozzles by turning switching elements (not illustrated) connected to the individual electrodes of the respective ejection energy generation elements on and off, in accordance with the ejection timing of the respective nozzles.

In this way, a drive signal for driving ejection of the respective nozzles is applied to the inkjet head 18 via the head drive circuit 388, thereby controlling the ink ejection volume and ejection timing of the inkjet head 18. By this means, a desired dot size and dot arrangement corresponding to the image data for printing are achieved.

Programs to be executed by the CPU of the control apparatus (system controller) 370 and various data required for control purposes are stored in the information storage unit 394.

The ultraviolet irradiation apparatus 50 which is combined with the inkjet recording apparatus 30 comprises the arm position sensor 46 for detecting the position of the take-up tension arm 24, and a control apparatus 510, a light source drive circuit 520 and the ultraviolet light source 42. The control apparatus 510 includes a timer 511 and a UV exposure control unit 512. The UV exposure control unit 512 is a control device which controls emission of light by the ultraviolet light source 42 via the light source drive circuit 520, while activating a timer 511, on the basis of a detection signal obtained from the arm position sensor 46.

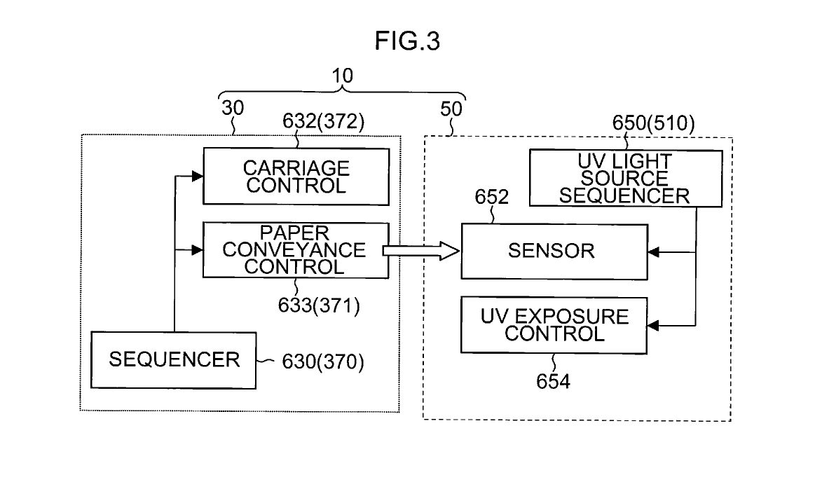

FIG. 3 is a block diagram showing an overview of a system composition of the image forming apparatus relating to the present embodiment. The image forming apparatus 10 according to the present embodiment has two independent sequencers (630 and 650) which respectively and independently control the inkjet recording apparatus 30 and the add-on type ultraviolet irradiation apparatus 50 which constitute the inkjet printing system. The first sequencer 630 which controls the inkjet recording apparatus 30 corresponds to the control apparatus 370 shown in FIG. 2. The first sequencer 630 (370) controls the respective functional modules which are required for inkjet printing, such as scanning control of main scanning and sub-scanning, control of ink supply, control of head maintenance, control of printing by the head (ejection control), and the like. In FIG. 3, in order to simplify the drawing, only the carriage control module 632 and the paper conveyance control module 633 are depicted. The carriage control module 632 and the paper conveyance control module 633 respectively correspond to the carriage drive control unit 372 and the recording medium conveyance control unit 371 shown in FIG. 2.

In FIG. 3, the second sequencer 650 which controls the add-on type ultraviolet irradiation apparatus 50 corresponds to the control apparatus indicated by reference numeral 510 in FIG. 2. This second sequencer 650 is independent of the first sequencer 630, and no control signals are exchanged between the two sequencers (630, 650). However, the second sequencer 650 detects a paper conveyance operation and halting of the paper conveyance operation by means of a sensor 652, for the purpose of coordinated operation with the first sequencer 630, and the results of this are used to control UV exposure within the range of management of the second sequencer 650. FIG. 3 shows a composition in which the second sequencer 650 controls the UV exposure control module 654 on the basis of the detection signal obtained from the sensor 652. As one example of the sensor 652, in FIG. 1 and FIG. 2, a combination of the arm position sensor 46 and the timer 511 is employed.

Various modes can be used as a device (detection device) for obtaining a detection signal of paper conveyance operation/paper conveyance halt which is used to control UV exposure by the second sequencer 650; for example, the compositions indicated below can be adopted. Furthermore, it is also possible to use a plurality of detection devices in a suitable combination.
(1) An encoder which detects the rotation of the paper feed roll (supply roller encoder)
(2) An encoder which detects the rotation of the take-up roll (take-up roller encoder)
(3) A combination of a limit switch on the take-up tension arm and a timer
(4) A paper speed determination sensor which determines the conveyance speed of the paper
(5) An encoder which detects movement of the carriage (carriage motor encoder)
(6) A temperature sensor which determines the temperature of the UV exposure platen (reference numeral 44 in FIG. 1)

The temperature sensor indicated in (6) does not detect the conveyance operation of the recording medium (paper) directly; rather, when UV exposure is continued while paper conveyance is halted, the temperature of the platen 44 is raised. The temperature of the platen 44 is higher when UV exposure is performed while conveyance is halted, compared to a case where UV exposure is performed during conveyance of the paper, and therefore halting of conveyance can be detected indirectly from the determination results of the temperature sensor. In other words, the temperature sensor may form an alternative device for determining a paper conveyance operation or conveyance halt.

The encoders given in the examples (1), (2), (4) and (5) above, and the like, are provided separately and independently as part of the composition of the add-on type ultraviolet irradiation apparatus 50, separately from encoders already installed as part of the composition of the inkjet recording apparatus 30. This is because, if an encoder, and the like, installed as part of the composition of the inkjet recording apparatus 30 is used, then extensive modifications are required, for instance, the connection of signal lines, and hence the merits of the add-on type apparatus are diluted.

As described above, the second sequencer 650 implements control such as automatic start of UV exposure (start of light emission), continuance of UV exposure, adjustment of the exposure amount, halting of UV exposure, and the like, in accordance with the detection results obtained from the sensor 652 which detects the conveyance operation based on the paper conveyance control performed under the management of the first sequencer 630.

In this way, by using the first sequencer 630 and the second sequencer 650 simultaneously, the whole of the image forming apparatus 10 functions as a UV curing printer.

### Comparative Example

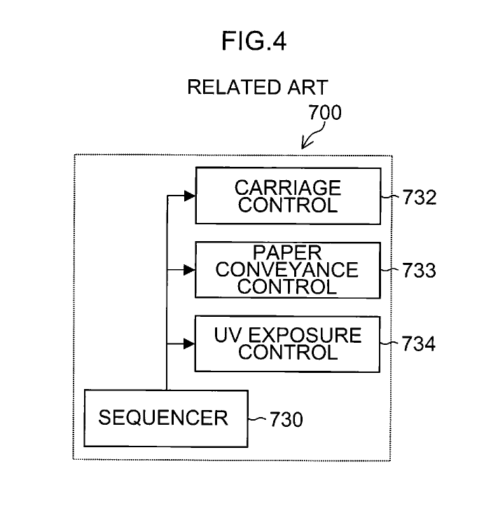

For the purpose of comparison, FIG. 4 shows a system composition diagram of a related-art UV curing printer. As shown in FIG. 4, in the related-art system 700, the carriage control module 732, the paper conveyance control module 733, the UV exposure control module 734 and the other respective functional modules are controlled by a sequencer 730 which performs comprehensive control of the whole system, and the control of UV exposure is managed as part of the whole sequence.

This kind of composition is not compatible with an add-on type system, and in order to change from a “UV curing system” to a “non-UV curing system (for example, a system using an eco-solvent ink)”, or in order to change from a “non-UV curing system” to a “UV curing system”, preliminary preparations are required, for instance, in order to prepare sequences corresponding to two modes, in advance. Extensive modifications are required in order to achieve compatibility with commercially available printers, and this is difficult to achieve in actual practice.

### Timing Chart of the Present Embodiment

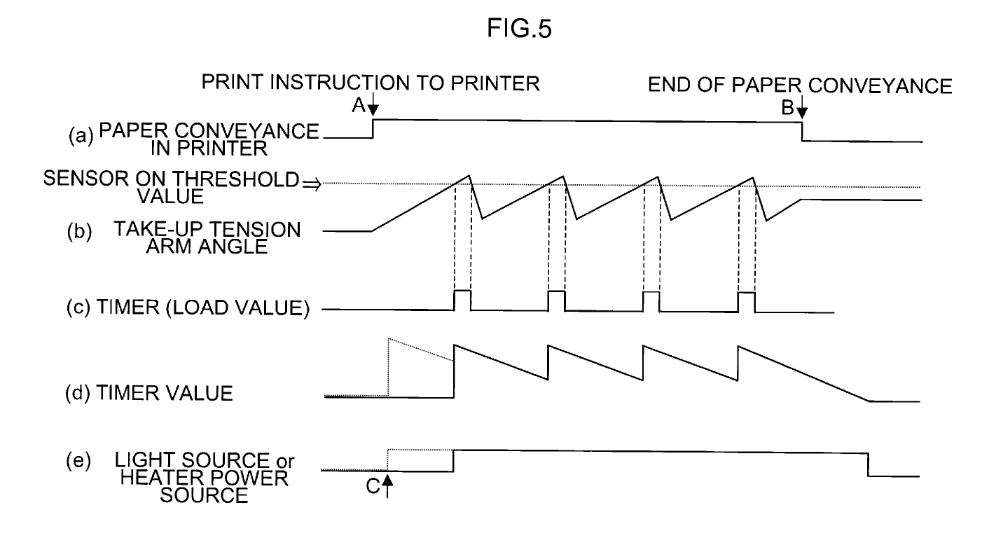

FIG. 5 illustrates a timing chart of a control sequence according to the system of the present embodiment. (a) of FIG. 5 illustrates a paper conveyance instruction signal which is managed by the control apparatus 370 of the inkjet recording apparatus 30 (first sequencer 630). At the timing indicated by arrow A, a print instruction is issued to the printer and the paper conveyance is started, while the paper conveyance is halted at the timing indicated by arrow B.

(b) of FIG. 5 indicates the arm angle of the take-up tension arm 24, and the dotted line represents the ON threshold value at which the arm position sensor 46 outputs an ON signal.

(c) of FIG. 5 represents a reset timing of the timer 511 which is synchronized with the ON signal by the arm position sensor 46 (a timing at which the initial timer value of the countdown timer is loaded). When the take-up tension arm 24 swings to an angle exceeding the ON threshold value ((b) of FIG. 5), the arm position sensor 46 outputs an ON signal ((c) of FIG. 5). The timer 511 is reset at the rise-up timing of the sensor signal.

(d) of FIG. 5 indicates change in the timer value. In the present embodiment, a countdown timer is employed and therefore the value of the timer gradually decreases from the value loaded at the reset timing. The initial timer value loaded at reset is set to a value longer than the swinging time interval of the take-up tension arm 24 (for example, 5 minutes). Paper conveyance is continued, and the timer 511 is reset at the timing that the take-up tension arm 24 has moved to the prescribed angle. When paper conveyance has ended and the take-up tension arm 24 has stopping moving, the countdown continues without resetting the timer 511, and therefore the timer 511 ultimately runs out (the timer value reaches zero).

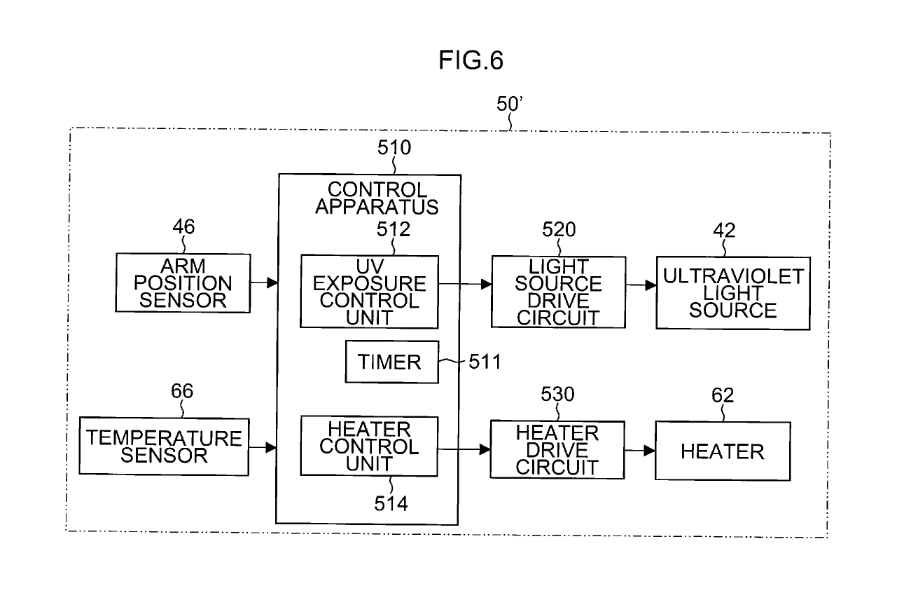

(e) of FIG. 5 indicates the timing of on/off switching of the ultraviolet light source 42 and the heater 62 (see FIG. 6) which is described below. The on/off switching of the ultraviolet light source 42 is managed by the timer 511. The ultraviolet light source 42 switches on at the operation timing (initial reset timing) of the timer 511 and the ON state is continued during the countdown period. The ultraviolet light source 42 switches off when the timer is halted.

As described with respect to FIG. 1, since the ultraviolet light source 42 is disposed to the downstream side of the image formation unit of the inkjet head 18 in terms of the paper conveyance direction, there is no particular need to switch the ultraviolet light source 42 simultaneously with the start of printing (or immediately after the start of printing), and it is sufficient for the ultraviolet light source 42 to be switched on before the image area arrives at the ultraviolet light irradiation unit.

The light emission start timing of the ultraviolet light source 42 is not limited to a mode where the light source is started up automatically at the initial reset timing of the timer 511, as described above. For example, it is also possible to start light emission from the ultraviolet light source 42 and to reset the timer 511 (load the initial value), by the operator manually operating a start switch, or the like. The portions marked by the broken lines in (d) and (e) of FIG. 5 indicate cases where the ultraviolet light source is switched on manually by the operator at the timing indicated by the arrow C.

### Control of Halting of UV Exposure Based on Halting or End of Paper Conveyance

According to the present embodiment, when paper conveyance is halted or ends, the take-up tension arm 24 also halts, whereupon the ultraviolet light source 42 switches off when the value of the timer 511 has reached zero. By this means, it is possible to prevent abnormal increase in the amount of UV irradiation as a result of the halting or the end of paper conveyance.

### Countermeasures in the Event of an Abnormality, Such as a Jam

According to the present embodiment, when the control apparatus 370 (first sequencer 630) of the inkjet recording apparatus 30 halts paper conveyance due to the occurrence of a jam or other abnormality, the take-up tension arm 24 is also halted and ceases to move, and therefore the value of the timer 511 eventually reaches zero and the ultraviolet light source 42 switches off. Therefore, excessive UV exposure does not continue and it is possible to avoid abnormal heat generation, and the like.

### Modifications for Reliable UV Exposure of the Image Area

By means of the user of the printer (the operator) additionally printing a white sheet image with a desired image which is a target of printing (in other words, by instructing output of a white sheet image), it is possible to perform UV exposure reliably on the image area on which an image has been formed before the white sheet image. Furthermore, the UV exposure can be composed so as to end (switching off of UV exposure) after a prescribed time period from the end of the image formation operation.

### Example of Control for Suppressing UV Curing Non-Uniformities

With a shuttle scanning type of image formation based on movement of the carriage 16, the conveyance of the paper in the sub-scanning direction is performed intermittently. In order to suppress UV curing non-uniformity caused by intermittent halting/conveyance of the paper, it is desirable to provide a device which reduces the amount of light exposure or switches exposure off when conveyance is halted.

The device for avoiding UV curing non-uniformities of this kind (non-uniformity avoidance device) may adopt a mode where the ultraviolet light source 42 is switched on and off, a mode where the amount of light emitted by the ultraviolet light source 42 is adjusted (light amount control is performed), a mode where a shutter provided with the ultraviolet light source 42 (a mechanical or a liquid crystal shutter) is controlled, or a suitable combination of these modes. A desirable mode is one where the amount of UV exposure light is controlled on the basis of a signal from a sensor which detects movement of the carriage 16 and movement of the recording medium 60.

### Further Action and Beneficial Effects of the Present Embodiment

According to the present embodiment, by connecting the add-on type ultraviolet irradiation apparatus 50 to the existing inkjet recording apparatus 30 which is not provided with a UV exposure function, a UV curing type image forming apparatus 10 can be obtained simply from the inkjet recording apparatus 30, with hardly any modifications or improvements. There are no structural restrictions on the inkjet recording apparatus 30 and an ultraviolet curing system can be realized by connecting an add-on type ultraviolet irradiation apparatus 50 to inkjet recording apparatuses of various types.

Furthermore, by detaching the add-on type ultraviolet irradiation apparatus 50 from the inkjet recording apparatus 30, and using general ink cartridges of eco-solvent (low-solvent) ink, aqueous pigment-based ink, aqueous dye-based ink, or the like, instead of the ultraviolet curable ink, then the inkjet recording apparatus 30 can be returned to a system using the original eco-solvent ink, or the like, and can be used as a conventional printer.

In this way, according to the present embodiment, it is extremely simple to change from a non-UV curing system (for example, a system using eco-solvent ink) to a UV curing system, and from a UV curing system to a non-UV curing system, and an existing inkjet recording apparatus can be utilized effectively.

### Other Embodiments

### Ultraviolet Irradiation Apparatus With Heater

FIG. 6 is a block diagram showing the composition of an add-on type ultraviolet irradiation apparatus relating to another embodiment of the present invention. In FIG. 6, elements which are the same as or similar to the composition shown in FIG. 2 are labeled with the same reference numerals and further explanation thereof is omitted here. It is also possible to use the ultraviolet irradiation apparatus 50′ shown in FIG. 6, instead of the ultraviolet irradiation apparatus 50 described in relation to FIG. 3.

The ultraviolet irradiation apparatus 50′ shown in FIG. 6 comprises a heater 62 which heats the recording medium 60, as well as irradiating ultraviolet light from the ultraviolet light source 42. The heater 62 is disposed close to the ultraviolet light source 42 (see FIG. 1), and similarly to the ultraviolet light source 42, has a paper width heating range in which the whole image formation range of the recording medium 60 in the width direction can be simultaneously heated. It is also possible to adopt a composition where a heater is provided inside the platen 44 and performs heating from the rear surface side of the recording medium 60.

Furthermore, the ultraviolet irradiation apparatus 50′ comprises a heater drive circuit 530 for driving the heater 62 and a temperature sensor 66 which determines the temperature of the platen 44. The control apparatus 510 includes a heater control unit 514, and controls the heater 62 via the heater drive circuit 530. The heater control unit 514 controls the on/off switching of the heater 62 by the same mechanism as the on/off control of the ultraviolet light source 42 which is described above in relation to (e) of FIG. 5. A timer for controlling the ultraviolet light source 42 and a timer for controlling the heater 62 are provided separately and can be controlled by different timer values.

### Modification Example 1

In the embodiments described above, a printing system (roll-to-roll system) which conveys a continuous medium from a paper feed roll (recording medium supply side supply roll) to a take-up roll is described by way of example, but the present invention can also be applied to a cut sheet printing system.

### Modification example 2

In the present embodiment, an inkjet recording apparatus which carries out image recording by a plurality of head scanning (moving) actions using a serial type (shuttle scanning type) of head is described as an example, but the range of application of the present invention is not limited to this and the present invention can also be applied to an inkjet recording apparatus using a page-wide full line type of head having a nozzle row of a length corresponding to the entire width of the recording medium (a single-pass type of image forming apparatus which completes an image of the prescribed resolution by means of one sub-scanning action).

### Examples of Applicable Apparatuses

The present invention can be applied effectively to a wide-format printer which is suitable for recording a wide image formation range, such as a large poster or commercial wall poster, or the like. Here, a printer compatible with a recording medium size of super A3 (329 mm×483 mm) or greater is called a “wide format”. However, the range of application of the present invention is not limited to such a wide format machine. Furthermore, the present invention is not limited to a graphic printing application, and can also be applied to various inkjet systems (image forming apparatuses) which are capable of forming various types of image pattern, such as a wire pattern forming apparatus which forms an image of a wiring pattern on an electronic circuit substrate, a manufacturing apparatus for various devices, a resist printing apparatus using resin liquid as a functional liquid for ejection (which corresponds to an “ink”), a fine structure forming apparatus, and the like.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An add-on type ultraviolet irradiation apparatus for being coupled to an inkjet recording apparatus that does not include an ultraviolet irradiation device for curing ultraviolet curable ink, so as to make the inkjet recording apparatus usable as an ultraviolet curing type image forming apparatus,
the add-on type ultraviolet irradiation apparatus comprising:
a detection device which detects a conveyance operation of a recording medium performed by the inkjet recording apparatus;
an ultraviolet light source for radiating ultraviolet light onto an ultraviolet curable ink deposited on the recording medium by the inkjet recording apparatus; and
an exposure control device which controls exposure performed by the ultraviolet light source according to a detection signal obtained from the detection device.

2. The add-on type ultraviolet irradiation apparatus as defined in claim 1, wherein the exposure control device is provided independently from a control device which controls an operation of the inkjet recording apparatus, and control of ultraviolet irradiation performed by the exposure control device and the operation of the inkjet recording apparatus performed by the control device are coordinated with each other via the detection signal from the detection device without transferring a control signal between the exposure control device and the control device, in such a manner that the inkjet recording apparatus functions as the ultraviolet curing type image forming apparatus.

3. The add-on type ultraviolet irradiation apparatus as defined in claim 1, wherein when a halt of conveyance of the recording medium is detected by the detection device, the exposure control device implements control to halt the exposure performed by the ultraviolet light source.

4. The add-on type ultraviolet irradiation apparatus as defined in claim 1, wherein when an operation of conveyance of the recording medium is detected by the detection device, the exposure control device implements control to start the exposure performed by the ultraviolet light source or to continue the exposure performed by the ultraviolet light source.

5. The add-on type ultraviolet irradiation apparatus as defined in claim 1, further comprising a platen which is disposed facing the ultraviolet light source and supports, from a rear surface side of the recording medium, the recording medium irradiated with the ultraviolet light from the ultraviolet light source.

6. The add-on type ultraviolet irradiation apparatus as defined in claim 5, further comprising a temperature sensor which detects a temperature of the platen,
wherein the temperature sensor is used as the detection device.

7. The add-on type ultraviolet irradiation apparatus as defined claim 1, wherein:
the recording medium is a continuous medium,
the add-on type ultraviolet irradiation apparatus further comprises an arm position sensor for determining a position of a take-up tension arm which is included in the inkjet recording apparatus and adjusts a tension when the continuous medium is taken up onto a take-up roll of the inkjet recording apparatus, and
the arm position sensor is used as the detection device.

8. The add-on type ultraviolet irradiation apparatus as defined in claim 7, further comprising a timer which is reset in accordance with a signal obtained from the arm position sensor.

9. The add-on type ultraviolet irradiation apparatus as defined in claim 1, further comprising:
a heater which heats the recording medium during ultraviolet irradiation performed by the ultraviolet light source; and
a heater control device which controls the heater according to the detection signal obtained from the detection device.

10. The add-on type ultraviolet irradiation apparatus as defined in claim 9, wherein when a halt of conveyance of the recording medium is detected by the detection device, the heater control device implements control to halt heating performed by the heater.

11. The add-on type ultraviolet irradiation apparatus as defined in claim 9, wherein when an operation of conveyance of the recording medium is detected by the detection device, the heater control device implements control to start heating performed by the heater or to continue the heating performed by the heater.

12. An image forming apparatus comprising:
the add-on type ultraviolet irradiation apparatus as defined in claim 1; and
the inkjet recording apparatus that is coupled to the add-on type ultraviolet irradiation apparatus,
wherein the inkjet recording apparatus includes:
an inkjet head which ejects the ultraviolet curable ink;
a conveyance device which conveys the recording medium on which the ultraviolet curable ink ejected from the inkjet head is deposited; and
a control device which controls an operation of the inkjet recording apparatus, the operation including control of conveyance of the recording medium performed by the conveyance device and control of ejection of the ultraviolet curable ink from the inkjet head.
